(19) United States
(12) Patent Application Publication
(10) Pub. No.: US 2016/0349189 A1
(43) Pub. Date: Dec. 1, 2016

(54) METHOD FOR EXAMINING WASHED OR CLEANED ITEMS OF LAUNDRY

(71) Applicant: Herbert Kannegiesser GmbH, Vlotho (DE)

(72) Inventors: Engelbert Heinz, Vlotho (DE); Wilhelm Bringewatt, Porta Westfalica (DE)

(73) Assignee: Herbert Kannegiesser GmbH, Vlotho (DE)

(21) Appl. No.: 15/158,934

(22) Filed: May 19, 2016

(30) Foreign Application Priority Data
Jun. 1, 2015 (DE) 102015006765.6

(51) Int. Cl. G01N 21/89; G01N 21/956; G01N 21/33; G01N 21/94

(52) U.S. Cl. CPC G01N 21/8914; G01N 21/94; G01N 21/956; G01N 21/33; G01N 2201/061; G01N 2201/062

(57) ABSTRACT

Contaminants, in particular stains, of cleaned or washed items of laundry can be on both sides. Therefore, it is necessary to examine washed or cleaned items of laundry on each side in respect of contaminants. This is very complicated. The invention provides for illuminating or transilluminating the items of laundry from one side by a lighting apparatus, as a result of which contaminants on this illuminated or transilluminated side of the items of laundry shine through to the opposite side. As a result, contaminants on both sides of the items of laundry are establishable from one side, which is directed away from the lighting apparatus, by way of a camera or the like. Therefore, as a result of the invention, it is not necessary to examine both sides of the items of laundry, either simultaneously or in succession, in respect of the presence of contaminants.

This application claims the benefit of and priority on German Patent Application No. 10 2015 006 765.6 having a filing date of 1 Jun. 2015.

### BACKGROUND OF THE INVENTION

### Technical Field

The invention relates to a method for examining washed or cleaned items of laundry wherein at least contaminants are detected by at least one camera directed onto one side of the respective item of laundry or by at least one sensor, to a method for examining washed or cleaned items of laundry wherein at least contaminants or patterns are detected by at least one camera directed onto at least one side of the respective item of laundry or by at least one sensor, and to a method for examining washed or cleaned items of laundry wherein at least one side of the respective item of laundry is scanned.

### Prior Art

It may be the case when cleaning or washing items of laundry of any type, in particular flat laundry and shaped parts (e.g. items of clothing), that it is not possible to remove all stains from the dirtied items of laundry, that holes are present and/or that the items of laundry still have other contaminants or adhesions, such as, in particular, hair or fibres. Hair adhering to the washed or cleaned items of laundry, in particular, is unacceptable. Such items of laundry may not be delivered back to the customer.

The degree of whiteness is also decisive, in particular in the case of so-called whites, especially if this relates to table linens.

It is known to examine contaminants, such as stains in particular, and holes or other impairments by scanning one side or area of the items of laundry. Until now, only those sides which were exposed in a suitable manner for scanning were examined.

### BRIEF SUMMARY OF THE INVENTION

The invention is based on the object of developing methods for examining washed or cleaned items of laundry, which admit a comprehensive examination in a simple manner.

A method for achieving the aforementioned object is a method for examining washed or cleaned items of laundry, wherein at least contaminants are detected by at least one camera directed onto one side of the respective item of laundry or by at least one sensor, characterized in that a side of the item of laundry lying opposite such a side associated with the at least one camera, the at least one sensor or any other imaging apparatus is illuminated. In this method, provision is made for a side lying opposite the at least one imaging apparatus, e.g. a camera or sensors, of the respective item of laundry being illuminated, irradiated and/or transilluminated. As a result, the respective item of laundry is backlit. As a result of backlighting and/or illuminating the relevant side, contaminants and/or adhesions on this side of the respective item of laundry shine through to the opposite side, which is associated with the at least one camera or the at least one sensor. As a result, contaminants and adhesions of the other, illuminated side of the item of laundry become visible for the at least one camera or the at least one sensor on the side lying opposite the illuminated side of the item of laundry.

As a result of backlighting the respective item of laundry, stains or other contaminants, and also adhesions such as e.g. hair, clearly shine through the respective item of laundry from the irradiated side, preferably the lower or rear side, namely even through a multi-layer item of laundry. As a result, it is also possible to reliably detect contaminants and/or adhesions on the side of the respective item of laundry not directly accessible to the camera or sensors by way of the at least one camera or the like on the opposite side, in particular the front side, of the item of laundry accessible thereto.

The method according to the invention renders it possible to detect and evaluate contaminants and adhesions on both sides of the item of laundry by means of at least one camera or a sensor or any other imaging apparatus on only one side, in particular the front side, of the item of laundry. Contaminants and/or adhesions on the one side, preferably the lower or rear side, are made visible on the opposite side, in particular the top or front side, such that these can be determined on both sides of the item of laundry by way of a camera or any other imaging apparatuses on only one side of the respective item of laundry.

Preferably, the side of the item of laundry which is shone upon, illuminated and/or backlit is the used side, which is generally formed by the finish side of the item of laundry. This is the side subsequently visible to the users. Therefore, it is particularly important for this side, the finish side, to be free from stains. After mangling, the used or finish side is situated on the rear side of the respective item of laundry. Illuminating or transilluminating the item of laundry on the side opposite the at least one sensor, scanner or the at least one camera allows contaminants and/or adhesions on the rear side to shine through the item of laundry, as a result of which contaminants on the rear side of the item of laundry can be recorded by the at least one imaging apparatus, preferably together with contaminants and adhesions on the front side.

Furthermore, provision is preferably made of carrying out the examination of the item of laundry in the spread-out state. As a result, an uninterrupted and complete illumination and/or transillumination of the item of laundry, preferably all over, and hence a total examination of also the rear side of the respective item of laundry are made possible.

In accordance with one advantageous possible refinement of the method, the examination takes place when the item of laundry is lying on at least one conveyor with the used side and/or the finish side spread-out, with the used and/or finish side lying on the conveyor preferably being shone upon, backlit or illuminated from below. As a result, the item of laundry is transilluminated, as a result of which stains or other contaminants, including adhesions, can also be detected on the side, preferably the rear side, directed away from the camera or the like. Thus, stains can be established on both sides of the item of laundry, even if the stains on the used or finish side, always lying below on the conveyor, are directed away from the camera, the scanner or the at least one sensor, because they lie on the side of the conveyor.

A further advantageous possible refinement of the method provides for the side lying opposite the at least one camera or the at least one scanner, preferably the used and/or finish side of the item of laundry, to be illuminated, preferably lit up and/or transilluminated, in a uniform manner and/or continuously over the whole width. As a result, all stains, foreign bodies and/or damage are made visible, even on the side lying opposite the scanner or the camera, and so these too are visible for the at least one camera or the at least one scanner and thus reliably detectable.

In particular, provision is made for the respective item of laundry to be illuminated or backlit from the side, preferably the used or finish side, lying opposite the at least one camera or the at least one scanner in such a way that the item of laundry is transilluminated. The transillumination of the item of laundry makes all stains or other contaminants, damage (holes) and also adhesions on this side visible on the opposite side, on which the at least one camera or the like is situated. Thus, it is also possible to establish, without turning the item of laundry over, stains or other contaminants or adhesions on the covered rear or lower side of the item of laundry, which are not or cannot be associated with a camera or the like because this side e.g. lies on a conveyor.

Another possible refinement of the method provides for the item of laundry to be illuminated and/or backlit in this way from a side directed away from the camera or the like, as a result of which there is a transillumination of the respective item of laundry. As a result, at least contaminants and adhesions on the backlit or irradiated side become visible on the opposite side of the item of laundry pointing to the at least one camera. Stains, adhesions, damage and other impairments of both sides of the item of laundry appear on the side on which the at least one camera or the like is directed.

A possible development of the method provides for both sides of the respective item of laundry to be illuminated. Thus, it is not only the side of the respective item of laundry directed away from the camera or the sensor that is illuminated, but there is also illumination of the opposite side, on which the camera or the sensor is directed. The illumination and/or transillumination of the item of laundry from both sides is particularly advantageous in the case of a multi-layer item of laundry. Contaminants, adhesions or else patterns of the item of laundry thus appear with more contrast for the camera or sensors, which makes the identification of stains, hair, patterns or the like on both sides of the respective item of laundry easier and more reliable, and also makes holes more easily identifiable.

A further method for independently achieving the object set forth at the outset, but also for possibly developing the above-described method, is a method for examining washed or cleaned items of laundry, wherein at least contaminants or patterns are detected by at least one camera directed onto at least one side of the respective item of laundry or by at least one sensor, characterized in that the form of the contaminants or patterns is established by the at least one camera or the at least one sensor and evaluated in respect of the geometry thereof. In this method, provision is made for the form and/or contours of contaminants, such as stains, adhesions, patterns, such as e.g. strips, ornaments, emblems, markings or the like, to be established and to be evaluated in respect of the geometry thereof. As a result, it is possible to draw conclusions about the type of contaminant, adhesions, or of the pattern.

Preferably, provision is made for establishing a length and width ratio of the established form or of the established contour of the respective contaminant. Preferably, it is possible to identify the form of the established contaminant, e.g. a hair or a fibre, on the basis of exceeding a specific, preferably predetermined length and width ratio. Hair, in particular, is perceived as very uncomfortable on washed and cleaned items of laundry. Therefore, it is important to be able to reliably identify such hair and, should hair be present in or on the item of laundry, not to deliver said item to the customer but rather to subject it to post-treatment or to wash or clean it again.

A further independent method for achieving the object set forth at the outset, which may, however, also relate to preferred developments of all or individual methods described above, is a method for examining washed or cleaned items of laundry, wherein at least one side of the respective item of laundry is scanned, characterized in that at least one side of the item of laundry is exposed to radiation and conclusions about the degree of whiteness of the respective item of laundry are drawn on the basis of the reflected radiation. In this method, at least one side of the respective item of laundry is exposed to radiation. Conclusions about the degree of brightness or whiteness of the respective item of laundry are drawn on the basis of the reflected radiation. Brighter, in particular whiter, laundry reflects the radiation differently. In particular, white laundry or bright laundry reflects more radiation, and so the intensity of the reflected radiation allows conclusions to be drawn about the degree of brightness or whiteness of the items of laundry. This method is particularly suitable for white laundry, but also for bright coloured laundry.

Preferably, the degree of whiteness of the items of laundry is established by comparing the reflected radiation, preferably the intensity of the reflected radiation, with reference values and/or a reference value spectrum. The reference values or the reference value spectrum can be stored in a controller or in a computer. The values are tiered according to greater and lesser degree of whiteness. Accordingly, the region of the reference value spectrum in which the value currently established on the item of laundry falls can be determined by comparing the value of the intensity of the reflected radiation established at the respective item of laundry with the values from the reference value spectrum. A higher value, corresponding to a greater reflection of the radiation, indicates a greater degree of whiteness than a lower value.

The radiation can relate to different types of visible or else invisible rays, preferably light rays, ultraviolet rays, infrared rays or the like.

In a preferred refinement of the method, provision is made for the items of laundry to be impinged upon by ultraviolet radiation (UV radiation) in order to establish the degree of whiteness. The scope and the intensity of reflected UV radiation are reliable indicators for the degree of whiteness of the items of laundry, and so the latter is particularly well-reproducible and, in particular, it supplies results that are easily comparable with reference values.

### BRIEF DESCRIPTION OF THE DRAWINGS

Preferred exemplary embodiments of the invention are explained in more detail below on the basis of the drawing. In detail:

FIG. 1 shows a schematic side view of a device for carrying out the method according to the invention, with a conveyor between a mangle and a subsequent folding machine, and

FIG. 2 shows a schematic side view of an alternative device for carrying out the method according to the invention.

### DETAILED DESCRIPTION OF PREFERRED EMBODIMENTS

In the shown exemplary embodiments, the methods according to the invention occur between a mangle 10 and a folding machine 11. After leaving an outlet region 13 of the mangle 10, each mangled item of laundry 12, shown from the side in the figures, is transported in the treatment direction 15 to the folding machine 11 by means of a conveyor. The mangled item of laundry 12 is folded automatically in the folding machine 11.

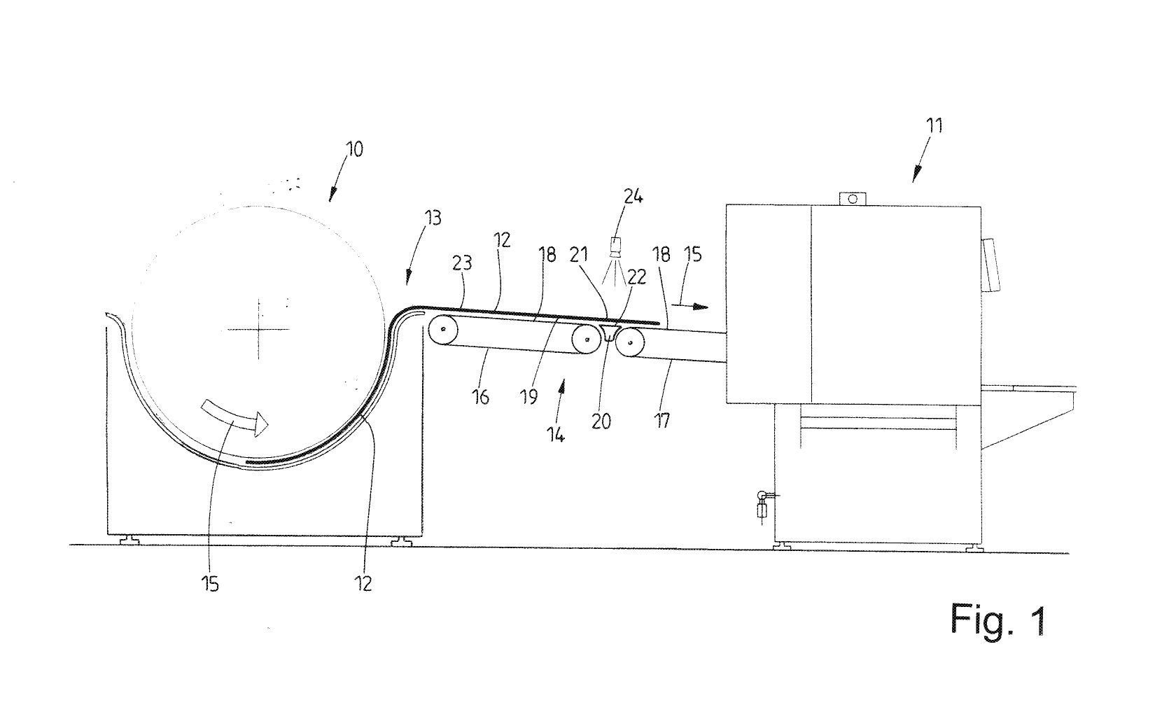

In the exemplary embodiment of FIG. 1, the conveyor 14 is formed by two successive conveyors, to be precise an outlet conveyor 16 behind the outlet region 13 of the mangle 10 and, adjoining this, an inlet conveyor 17 in front of the folding machine 11. The outlet conveyor 16 and the inlet conveyor 17 are equally embodied as a belt conveyor with a circulating belt drive. The outlet conveyor 16 and the inlet conveyor 17 can have a conveyor belt continuous over the whole work width, or else a plurality of narrow conveyor belts lying next to one another. Mangled, and hence spread-out, preferably spread-out flat, items of laundry 12 are transported in succession without overlap, preferably at a distance from one another, in the treatment direction 15 to the folding machine 11 by way of the top strands 18 of the outlet conveyor 16 and of the inlet conveyor 17. In the case of a multi-web mode of operation, the items of laundry 12 can also lie next to one another on the conveyor 16, 17 in a plurality of webs. Optionally, the top strands 18 can be perforated in order to affix the spread-out items of laundry 12 on the outlet conveyor 16 or the inlet conveyor 17, at least in regions, by way of negative pressure. Alternatively, it is also conceivable for the outlet conveyor 16 and the inlet conveyor 17 to be provided with web-like belts. The items of laundry 12 then lie on the web-like or grid-like top strand 18. As a result, a lower side of each item of laundry 12 lying on the conveyor 14 is left almost completely exposed by the conveyor belt of the conveyor 14, in particular of the outlet conveyor 16 and the inlet conveyor 17.

The items of laundry 12 leave the mangle 10 with a finish side 19 lying at the bottom because the finish side 19 of the items of laundry 12 usually forms on the lower, stationary mangling trough. Mangles with a different construction, for example belt mangles, can also be left by the items of laundry 12 with the finish side 19 up. Therefore, the invention is not restricted to only items of laundry 12 with the finish side 19 lying at the bottom.

The finish side 19 is the subsequent used side of the items of laundry 12, to be precise the top side in the case of table linen. Since the finish side 19 forming the subsequent top side of the items of laundry 12 lies at the bottom when leaving the mangle 10 and hence on the top strand 18 of the conveyor 14, or of the outlet conveyor 16 and inlet conveyor 17, following the mangle 10, patterns, holes and contaminants, in particular stains, are only establishable with difficulty when the finish side 19 of the item of laundry 12 lies at the bottom. Previously, the respective item of laundry 12 had to be turned to this end.

According to the invention, at least one lighting apparatus 20 is provided between the mangle 10 and the folding machine 11. The lighting apparatus 20 is arranged between the mangle 10 and the folding machine 11 in such a way that it illuminates or shines upon the items of laundry 12 from below, preferably from the finish sides 19 thereof lying at the bottom, as a result of which the items of laundry 12 are backlit and/or transilluminated. Accordingly, the luminosity of the lighting apparatus 20 is rated in such a way that holes, patterns, adhesions and contaminants, in particular stains, on the lower side of the respective item of laundry 12 shine through to the upper, exposed side and are also visible there.

The lighting apparatus 20 illuminates a transverse strip 21 of each item of laundry 12 extending across the treatment direction 15. To this end, the width of the lighting apparatus 20 corresponds to the width of the conveyor 14, in particular of the outlet region 16 and of the inlet region 17 with the same width.

In the exemplary embodiment of FIG. 1, the lighting apparatus 20 is associated with the conveyor 14 in such a way that it is situated between the outlet conveyor 16 and the inlet conveyor 17. Here, the lighting apparatus 20 bridges a gap between the outlet conveyor 16 and the inlet conveyor 17, that is to say it is situated in an upper wedge region of the conveyor 14 lying before the adjacent deflection drums or drive drums of the outlet conveyor 16 and the inlet conveyor 17. To this end, the cross section of the lighting apparatus 20 is matched to this upper wedge region of the conveyor 14 such that a top side 22, which is plane in the shown exemplary embodiment, of a housing of the lighting apparatus 20 is situated approximately in the plane of the top strand 18 of the conveyor 14, in particular of the outlet conveyor 16 and inlet conveyor 17. The lighting means, preferably LED lighting means, can be housed in the housing of the lighting apparatus 20, to be precise in such a way that rays emanating from the lighting means are directed upward through the top side 22 of the housing toward the lower side of the item of laundry 12. It is also conceivable to adhesively bond onto the top side 22 of the housing light strips with small LED lighting means arranged thereon. Here, the LED lighting means are oriented, in turn, in such a way that the light rays emitted thereby are directed against the lower side of the item of laundry 12 and are incident on the lower side, preferably the finish side 19, of the item of laundry 12.

The side opposite the conveyor 14, in particular a top side 23 of the item of laundry 12, is associated with an imaging apparatus which, in the shown exemplary embodiment, is embodied as at least one camera 24. The camera 24 is positioned in a stationary manner at a distance above the item of laundry 12. The camera 24 is positioned such that the camera 24 images, preferably over the whole area, the top side 23 of the item of laundry 12. Here, the camera 24 is embodied in such a way that it detects over the entire width thereof at least the transverse strip 21 of the item of laundry 12 which is backlit, shone upon and/or transilluminated in a uniform and complete, in particular uninterrupted manner by the lighting apparatus 20 and, therefrom, generates an image with the contaminants, holes, patterns or the like on the lower, transilluminated finish side 19 and, at the same time, preferably on the top side 23 as well.

If need be, at least one lighting source can also still be provided on the side of the camera 24. This lighting source can optionally be integrated into the camera 24. The at least one lighting source on the side of the camera 24, i.e. the exposed top side of the item of laundry 12, preferably also lights up a transverse strip 21 of the item of laundry 12 over the whole width thereof. This at least one lighting source can also be a row of a plurality of LED lighting means. These lighting means generate incident light directed to the exposed top side of the item of laundry 12. In this case, the item of laundry is illuminated on both sides in the region of the transverse strip 21, to be precise with incident light on the exposed top side, and it is backlit and transilluminated with light on the opposite lower side facing the conveyor 14. The illumination from both sides, in particular the shining onto and through the respective item of laundry 12, simplifies and improves the identification of impairments of the respective item of laundry 12, in particular of stains, holes or the like. The two-sided illumination and transillumination of the respective item of laundry 12 also allows an improved and reliable identification of patterns of the item of laundry 12 or of foreign bodies, for example hair, on same.

It is conceivable to provide a plurality of cameras 24 or other imaging apparatuses, in particular in a row extending across the treatment direction 15. Alternatively, provision could also be made of light-sensitive sensors in place of the camera 24; a plurality of sensors in the style of a scanner could be preferably arranged next to one another equidistantly in a row extending across the treatment direction 15 such that they scan the whole width of the item of laundry 12, or the width of a plurality of items of laundry 12 lying next to one another, without gaps.

The at least one camera 24 is preferably provided with an auto-focusing optical unit. This renders automatic focusing possible. As a result, it is possible, for example, also to identify impairments or foreign bodies on an item of laundry 12 which does not lie flat on the conveyor 14 in the region of the at least one camera 24, but instead slightly arches upward. Moreover, the automatic focusing of the at least one camera 24 is able, where necessary, to undertake an adjustment in such a way that, for example, stains on the top side of the item of laundry 12 pointing toward the camera 24 and/or stains transilluminated from the lower side of the item of laundry 12, shone upon from below, or the like appear in focus. The automatic adjustment of the optical unit of the at least one camera 24 can also be carried out in a manner depending on what is being currently recorded, for example a stain, a hole, a pattern or the like.

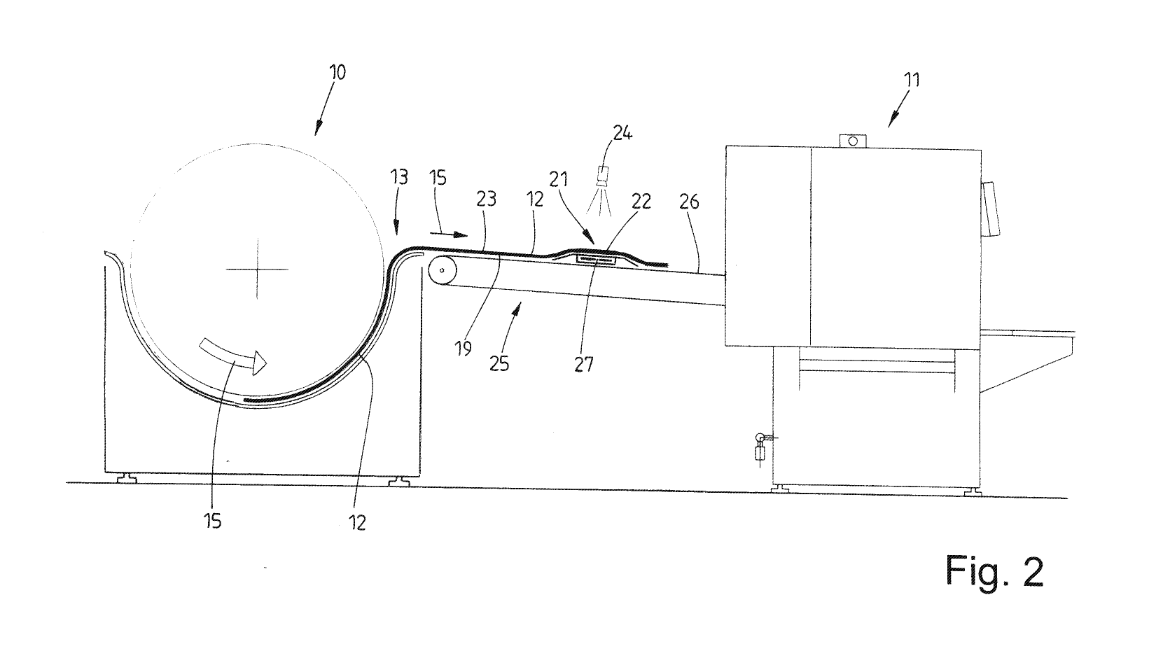

FIG. 2 shows an alternative exemplary embodiment with a single continuous conveyor 25 between the mangle 10 and the folding machine 11. A lighting apparatus 27, which is continuous over the entire width of the conveyor 25 across the treatment direction 15, is arranged tightly above a top strand 26 of this conveyor 25. The top strand 26 is guided below the lighting apparatus 27, with corresponding guiding sheets deflecting the item of laundry 12 from the top strand 26 in the region of the lighting apparatus 27, in particular lifting said item of laundry such that the item of laundry 12 is transported over the lighting apparatus 27 in the region of same. As a result, the lighting apparatus 27 is not covered by the top strand 26, and so the lighting apparatus 27 comes into direct contact with the lower side, in particular the finish side 19, of the item of laundry 12 and it is able to shine upon and/or transilluminate the latter from below such that stains, holes or the like on or in the lower side of the item of laundry 12 shine through to the top side of same and are thus also detectable by the at least one camera 24 assigned with the top side of the item of laundry 12. If the top strand 26 is guided over the lighting apparatus 27, the top strand 26 of the conveyor 14 either has a light-transmissive embodiment or it has a web-like or grid-like embodiment and it is therefore almost completely light transmissive.

Deviating from the exemplary embodiment in FIG. 2, a lighting apparatus 27 with a flat embodiment can also be arranged between the strands of the conveyor 25 such that the top side 22 of the lighting apparatus 27 coming into contact with the lower side, in particular the finish side 19, of the respective item of laundry 12 lies in the main plane of the top strand 26 (upstream and downstream of the lighting apparatus 27) and, as a result thereof, the lighting apparatus 27, in contrast to the exemplary embodiment in FIG. 2, does not form an elevation over the top strand 26 of the conveyor 25.

The lighting apparatus 27 can be embodied like the lighting apparatus 20 described in more detail in the preceding exemplary embodiment. In order to avoid repetition, reference is made to the description of the lighting apparatus 20.

Below, the method according to the invention is explained in more detail on the basis of the device of FIG. 1:

Using the method according to the invention, it is possible to establish contaminants, in particular stains, but also holes, adhesions, e.g. hair, and the like, on the top side 23 and the lower side, in particular the finish side 19, of items of laundry 12 at the same time, without needing to turn the items of laundry 12. Contaminants, especially stains and adhesions, and also holes are established continuously on the path of the item of laundry 12 from the mangle 10 to the folding machine 11. As a result of this, it is possible to detect the contaminants, holes and adhesions on the mangled item of laundry 12, which preferably lies in a flat and stretched manner on the top strand 18 of the conveyor 14 between the mangle 10 and the folding machine 11.

The at least one camera 24 or another imaging apparatus is used to record, continuously and successively, respectively one transverse strip 21 of the item of laundry 12 with both lower adhesions and contaminants shining through and upper contaminants and adhesions, and also holes, as said item of laundry passes. In the process, the camera 24 continuously scans the whole top side 23 of the item of laundry over the whole area thereof and generates at least one image thereof.

Contaminants, in particular stains, on the top side 23 of the respective item of laundry 12 are detected directly by the camera 24. According to the invention, contaminants, in particular stains, on the lower side or finish side 19, pointing toward the top strand 18 of the conveyor 14 or lying thereon, of the respective item of laundry 12 are also established from the top side 23 by the camera 24 by virtue of the lower side, in particular the finish side 19, of the respective item of laundry being illuminated or irradiated by the at least one lighting apparatus 20. This is carried out in such a way that the item of laundry 12 is transilluminated from the finish side 19, as a result of which contaminants, in particular stains, of the lower side or the finish side 19 of the respective item of laundry 12 shine through the item of laundry 12 and are thereby also establishable, in particular imageable, by the camera 24 on the top side 23 of the item of laundry 12. In this manner, the at least one camera 24, or any other imaging apparatus, only associated with one side of the item of laundry 12 can simultaneously establish not only holes or other damage, but also contaminants, on both the top side 23 and on the lower side, for example the finish side 19. To this end, the lighting means or lighting sources of the lighting apparatus 20 are embodied to generate sufficient light such that stains or other contaminants on the lower side or finish side 19 of the respective item of laundry 12 shine through same and become visible on the top side 23 to the at least one camera 24 or any other imaging apparatus.

In principle, in the device of FIG. 2, the method is run through exactly as described above.

According to the method, provision is furthermore made for the at least one camera 24 or any other imaging apparatus or for sensors to establish the form of the contaminant or the adhesion whilst the item of laundry 12 continuously runs past it and to evaluate this form in respect of the geometry thereof.

Length and width dimensions of the contaminants are preferably established and a length-to-width ratio is established therefrom. The established length-to-width ratio is compared to a predetermined length-to-width ratio in an electronic evaluation apparatus. If this comparison yields that the contaminant reaches or exceeds the predetermined length and width ratio, this is an indication for a specific contaminant. Preferably, this method is used to establish hair or fibres with a relatively large length-to-width ratio situated on the respective item of laundry. This large length-to-width ratio allows reliable conclusions to be drawn about hair or fibres if the evaluation yields that this large length-to-width ratio is reached or exceeded.

The determination, explained above, of contaminants with e.g. hair on the basis of establishing the length and width ratio of same can also be carried out on both sides of the item of laundry 12. By shining upon or backlighting a lower side of the item of laundry 12, the latter is transilluminated and, as a result, made virtually invisible, and so contaminants and adhesions, such as e.g. hair, also present on the lower side of the item of laundry 12 shine through the item of laundry 12 and, as a result thereof, become visible on the top side of same. Therefore, contaminants and adhesions can be detected and determined on both sides of a respective item of laundry 12.

According to the method, provision is furthermore made for at least one side of the item of laundry 12 to be exposed to radiation when it passes by the camera 24 and for the reflected radiation to be detected by e.g. the camera 24 or else another sensor means or detection means. In particular, light rays, ultraviolet radiation and/or infrared radiation come into question as radiation.

The intensity of the established reflected radiation is an indication for the degree of whiteness of the item of laundry 12. Particularly high amounts of reflected radiation allow the conclusion to be drawn that this is a very white or bright item of laundry 12. Thus, it is possible to determine how bright or how white the item of laundry 12 is by way of a comparison with reference values or a reference value spectrum. If predetermined guidelines or thresholds are exceeded in the process, i.e. if the item of laundry is too bright or too dark, the washing process of subsequent items of laundry 12 is influenced by virtue of substances which are active during the wash and/or bleaching means being modified accordingly in terms of the dose thereof.

The invention is also suitable for so-called dry laundry, which, after washing and without prior mangling, is placed directly on the inlet conveyor 17 leading to the folding machine 11 and fed to the folding machine 11 from there. Here, the above-described method then takes place in the region of the inlet conveyor 17 upstream of the folding machine 11.

The method according to the invention can also be performed on hanging items of laundry 12, in particular items of laundry hanging in a stretched manner. Then, the at least one camera 24 is associated with one side of the hanging item of laundry 12 and the lighting apparatus 20 is associated with the opposite side. Contaminants and/or adhesions, such as e.g. hair on the side of the lighting apparatus 20, then shine through to the opposite side of the item of laundry 12 associated with the camera 24 by way of being illuminated by the lighting apparatus 20 and then also become visible on the side of the imaging apparatus, such as e.g. the camera 24. As a result, contaminants or adhesions on both sides of the items of laundry 12 are made visible due to transillumination of same and the shining through, caused thereby, of contaminants and adhesions on the side of the items of laundry 12 pointing to the camera 24 and on the lying on the opposite side of the items of laundry 12 facing the lighting apparatus 20, by the camera 24, even in the case of hanging items of laundry 12. Thus, contaminants of both sides of the items of laundry 12 also become visible and detectable to the at least one camera 24 on the side of the items of laundry 12 facing the at least one camera 24.

An electronic, automatic evaluation, for example a computer-assisted image evaluation of the images detected by the at least one camera 24, the sensor or any other imaging apparatus, is provided. Optionally, the image evaluation can filter out the structure of the fabric of the items of laundry 12. As a result, this ensures that the fabric structure of the items of laundry 12 does not impair the identification of contaminants (stains) and/or adhesions (hair).

Furthermore, provision can be made for the item of laundry to be identified at the same time by the at least one camera, sensors or the like, such that it is possible to establish what item of laundry this is. This renders it possible to determine whether the same impairment, for example the same stain or the same hole, was identified a number of times on the same item of laundry. By way of example, if the same stain is detected a number of times, this indicates that this stain can no longer be removed. Such an item of laundry can then be removed and need not be washed repeatedly. It is also possible to determine how a specific stain changes during repeated washing or any other treatment. If no change is determined, this indicates an impairment, for example a stain, which is non-removable. However, if the impairment, for example the stain, reduces in size during repeated washing, it is possible to attempt to remove the stain further or completely by washing that is repeated at least once.

### LIST OF REFERENCE SIGNS

10 Mangle
11 Folding machine
12 Item of laundry
13 Outlet region
14 Conveyor
15 Treatment direction
16 Outlet conveyor
17 Inlet conveyor
18 Top strand
19 Finish side
20 Lighting apparatus
21 Transverse strip
22 Top side (of 20 and 27)
23 Top side
24 Camera
25 Conveyor
26 Top strand
27 Lighting apparatus

What is claimed is:

1. A method for examining washed or cleaned items of laundry (12), wherein at least contaminants are detected by at least one camera (24) directed onto one side of the respective item of laundry (12) or by at least one sensor, wherein a side of the item of laundry (12) lying opposite such a side associated with the at least one camera (24), the at least one sensor or any other imaging apparatus is illuminated.

2. The method according to claim 1, wherein such a side of the respective item of laundry (12) which is the finish side (19) of the item of laundry (12) is illuminated.

3. The method according to claim 1, wherein the examination is undertaken in the spread-out state of the item of laundry (12).

4. The method according to claim 1, wherein at least contaminants on the illuminated side of the item of laundry (12) shine through same and thereby become visible on the opposite side of the item of laundry (12) which is associated with the at least one camera (24) or the at least one sensor.

5. The method according to claim 1, wherein the examination is carried out in the state of the item of laundry (12) where it is lying with the finish side (19) spread out on a conveyor (14, 25), with the finish side (19) of the item of laundry (12) lying on the conveyor (14, 25) being illuminated and, in so doing, being transilluminated.

6. The method according to claim 1, wherein the side of the item of laundry (12) lying opposite the at least one camera (24) or the at least one sensor is illuminated and transilluminated in a uniform manner over the entire width thereof during the continuous onward transport of the respective item of laundry (12) in the treatment direction (15) by way of the conveyor (14, 25).

7. The method according to claim 1, wherein the items of laundry (12) are illuminated from the side lying opposite the at least one camera (24) or the at least one sensor in such a way that they are transilluminated and, in so doing, at least contaminants on the finish side (19) shine through the items of laundry (12) and hence at least the contaminants on the finish side (19) of the items of laundry (12) are also visible on the opposite side of the items of laundry (12) which is associated with the at least one camera (24) or the at least one sensor.

8. The method according to claim 1, wherein in that the items of laundry (12) are illuminated from the side thereof directed away from the at least one camera (24) or the at least one sensor in such a way that at least contaminants on the illuminated side become visible to the at least one camera (24) or the at least one sensor on the (other) side of the items of laundry (12) pointing to the at least one camera (24) or the at least one sensor by virtue of shining through the items of laundry (12).

9. The method according to claim 2, wherein the examination is undertaken in the spread-out state of the item of laundry (12).

10. A method for examining washed or cleaned items of laundry (12), wherein at least contaminants or patterns are detected by at least one camera (24) directed onto at least one side of the respective item of laundry (12) or by at least one sensor, wherein the form of the contaminants or patterns is established by the at least one camera (24) or the at least one sensor and evaluated in respect of the geometry thereof.

11. The method according to claim 10, wherein a length-to-width ratio of the established form of the respective contaminant is established and compared to a specific, predetermined length-to-width ratio, with reaching and exceeding the predetermined length and width ratio being evaluated as a specific contaminant.

12. A method for examining washed or cleaned items of laundry (12), wherein at least one side of the respective item of laundry (12) is scanned, wherein at least one side of the item of laundry (12) is exposed to radiation and conclusions about the degree of whiteness of the respective item of laundry (12) are drawn on the basis of the reflected radiation.

13. The method according to claim 12, wherein the degree of whiteness of the respective item of laundry (12) is established by comparing the reflected radiation or the intensity of the reflected radiation with reference values.

14. The method according to claim 12, wherein ultraviolet radiation is used as radiation.

15. The method according to claim 13, wherein ultraviolet radiation is used as radiation.
